(19) United States
(12) Patent Application Publication
(10) Pub. No.: US 2005/0021272 A1
(43) Pub. Date: Jan. 27, 2005

(54) Method and apparatus for performing metrology dispatching based upon fault detection

(76) Inventors: Naomi M. Jenkins, Round Rock, TX (US); Timothy L. Jackson, Pflugerville, TX (US); Howard E. Castle, Austin, TX (US); Brian K. Cusson, Austin, TX (US)

Correspondence Address: WILLIAMS, MORGAN & AMERSON, P.C., 10333 RICHMOND, SUITE 1100, HOUSTON, TX, 77042, US

(21) Appl. No.: 10/614,604

(22) Filed: Jul. 7, 2003

(51) Int. Cl. G06F 19/00

(52) U.S. Cl. 702/105

(57) ABSTRACT

A method and an apparatus for dynamically adjusting a metrology routing of a batch of workpieces. The method comprises performing a process step upon a batch of workpieces using a processing tool, performing a tool state analysis upon the processing tool, and performing a dynamic metrology routing adjustment process based upon the tool state analysis. The dynamic metrology routing adjustment process further comprises correlating the tool state analysis to the batch of workpieces and adjusting a metrology routing based upon the correlation.

### BACKGROUND OF THE INVENTION

1. Field of the Invention

This invention relates generally to semiconductor manufacturing, and, more particularly, to a method and apparatus for performing metrology dispatching based upon a fault detection analysis.

2. Description of the Related Art

The technology explosion in the manufacturing industry has resulted in many new and innovative manufacturing processes. Today's manufacturing processes, particularly semiconductor manufacturing processes, call for a large number of important steps. These process steps are usually vital, and therefore, require a number of inputs that are generally fine-tuned to maintain proper manufacturing control.

The manufacture of semiconductor devices requires a number of discrete process steps to create a packaged semiconductor device from raw semiconductor material. The various processes, from the initial growth of the semiconductor material, the slicing of the semiconductor crystal into individual wafers, the fabrication stages (etching, doping, ion implanting, or the like), to the packaging and final testing of the completed device, are so different from one another and specialized that the processes may be performed in different manufacturing locations that contain different control schemes.

Generally, a set of processing steps is performed across a group of semiconductor wafers, sometimes referred to as a lot. For example, a process layer that may be composed of a variety of different materials may be formed across a semiconductor wafer. Thereafter, a patterned layer of photoresist may be formed across the process layer using known photolithography techniques. Typically, an etch process is then performed across the process layer using the patterned layer of photoresist as a mask. This etching process results in the formation of various features or objects in the process layer. Such features may be used as, for example, a gate electrode structure for transistors. Many times, trench isolation structures are also formed across the substrate of the semiconductor wafer to isolate electrical areas across a semiconductor wafer. One example of an isolation structure that can be used is a shallow trench isolation (STI) structure.

The manufacturing tools within a semiconductor manufacturing facility typically communicate with a manufacturing framework or a network of processing modules. Each manufacturing tool is generally connected to an equipment interface. The equipment interface is connected to a machine interface to which a manufacturing network is connected, thereby facilitating communications between the manufacturing tool and the manufacturing framework. The machine interface can generally be part of an advanced process control (APC) system. The APC system initiates a control script, which can be a software program that automatically retrieves the data needed to execute a manufacturing process.

FIG. 1 illustrates a typical semiconductor wafer 105. The semiconductor wafer 105 typically includes a plurality of individual semiconductor die 103 arranged in a grid 150. Using known photolithography processes and equipment, a patterned layer of photoresist may be formed across one or more process layers that are to be patterned. As part of the photolithography process, an exposure process is typically performed by a stepper on single or multiple die 103 locations at a time, depending on the specific photomask employed. The patterned photoresist layer can be used as a mask during etching processes, wet or dry, performed on the underlying layer or layers of material, e.g., a layer of polysilicon, metal or insulating material, to transfer the desired pattern to the underlying layer. The patterned layer of photoresist is comprised of a plurality of features, e.g., line-type features or opening-type features that are to be replicated in an underlying process layer.

Turning now to FIG. 2, a flow chart depiction of a prior art process flow is illustrated. Generally, a manufacturing system processes a plurality of lots/batch of semiconductor wafers 105 (block 210). Generally, these lots are queued and routed through a manufacturing stream. Upon processing of the semiconductor wafers 105, the manufacturing system may acquire metrology data from a sample of semiconductor wafers 105 in the batch/lot that are in queue for metrology analysis (block 220). Generally, a first-in-first-out approach is used in acquiring metrology data on the semiconductor wafers 105. In other words, the first lots to be processed are first sent for metrology analysis. However, this system may cause the manufacturing system to acquire metrology data after a long delay since these lots generally wait in the queue for metrology analysis. Meanwhile, several process steps may be performed by the processing tools that originally processed the wafers 105 in the lots. Upon acquisition of metrology data, the metrology data is analyzed (block 230). Based upon this analysis, process corrections may be performed by the manufacturing system (block 240).

One of the problems associated with the current methodology includes the fact that many lots/batches of semiconductor wafers 105 may be queued, therefore, analysis of metrology data may occur at a significantly later time period. Meanwhile, some batches may continue through other processes before a determination is made that a significant amount of errors may exist in a particular batch. Additionally, a defective processing tool may continue operations until a lot in a queue is analyzed. Many times, a determination whether there are flaws in a batch of semiconductor wafers 105 or in a processing tool itself is made after a significant delay. Therefore, a flawed processing tool may be allowed to continue to operate, or a flawed batch of semiconductor wafers 105 may be processed through a manufacturing system, before the error is detected and/or corrected. This may result in inefficiencies in the manufacturing process and an appreciable number of failures in processed semiconductor wafers 105. This may affect the yield of wafer production and may prove to be costly.

The present invention is directed to overcoming, or at least reducing, the effects of, one or more of the problems set forth above.

### SUMMARY OF THE INVENTION

In one aspect of the present invention, a method is provided for dynamically adjusting a metrology routing of a batch of workpieces. The method comprises performing a process step upon a batch of workpieces using a processing tool, performing a tool state analysis upon the processing tool, and performing a dynamic metrology routing adjustment process based upon the tool state analysis. The dynamic metrology routing adjustment process further comprises correlating the tool state analysis to the batch of workpieces and adjusting a metrology routing based upon the correlation.

In another aspect of the present invention, a method is provided for dynamically adjusting a metrology routing of a batch of workpieces. The method comprises performing a process step upon a plurality of batches of workpieces using a processing tool, performing a tool health analysis upon the processing tool, and performing a fault detection analysis relating to the processing of the batches of workpieces. The method further comprises correlating the tool health assessment to at least one of the batches of workpieces based upon the tool health analysis and the fault detection analysis and adjusting a metrology routing of at least one of the batches of workpieces based upon the correlation.

In another aspect of the present invention, a system is provided for dynamically adjusting a metrology routing of a batch of workpieces. The system includes a processing tool to process a workpiece. The system also includes a process controller operatively coupled to the processing tool. The process controller is capable of performing a tool state analysis upon the processing tool and to performing a dynamic metrology routing adjustment process based upon the tool state analysis. The dynamic metrology routing adjustment process further comprises correlating the tool state analysis to the batch of workpieces and adjusting a metrology routing based upon the correlation.

In another aspect of the present invention, an apparatus is provided for dynamically adjusting a metrology routing of a batch of workpieces. The apparatus includes a process controller adapted to perform a tool state analysis upon a processing tool that is capable of processing a batch of workpieces and to perform a dynamic metrology routing adjustment process based upon the tool state analysis. The dynamic metrology routing adjustment process further comprises correlating the tool state analysis to the batch of workpieces and adjusting a metrology routing based upon the correlation.

In yet another aspect of the present invention, a computer readable program storage device encoded with instructions is provided for dynamically adjusting a metrology routing of a batch of workpieces. The computer readable program storage device encoded with instructions that, when executed by a computer, performs a method, which comprises performing a process step upon a batch of workpieces using a processing tool, performing a tool state analysis upon the processing tool, and performing a dynamic metrology routing adjustment process based upon the tool state analysis. The dynamic metrology routing adjustment process further comprises correlating the tool state analysis to the batch of workpieces and adjusting a metrology routing based upon the correlation.

### BRIEF DESCRIPTION OF THE DRAWINGS

The invention may be understood by reference to the following description taken in conjunction with the accompanying drawings, in which like reference numerals identify like elements, and in which:

FIG. 1 is a simplified diagram of a prior art semiconductor wafer being processed;

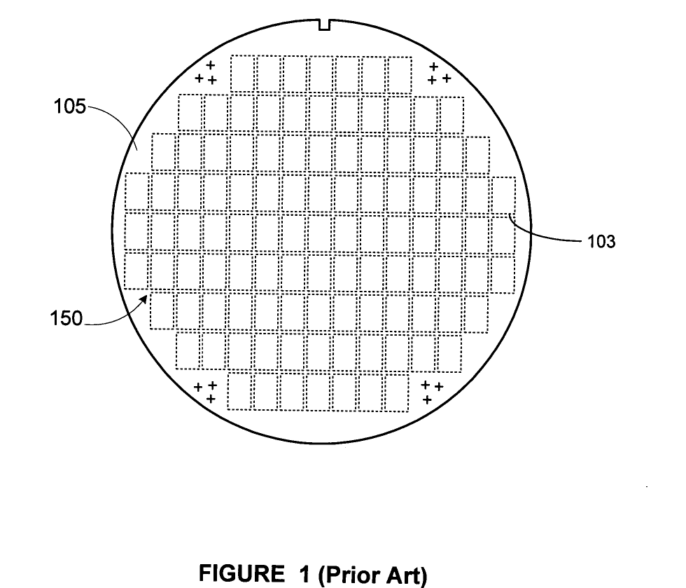

FIG. 2 illustrates a simplified flowchart depiction of a prior art process flow during manufacturing of semiconductor wafers;

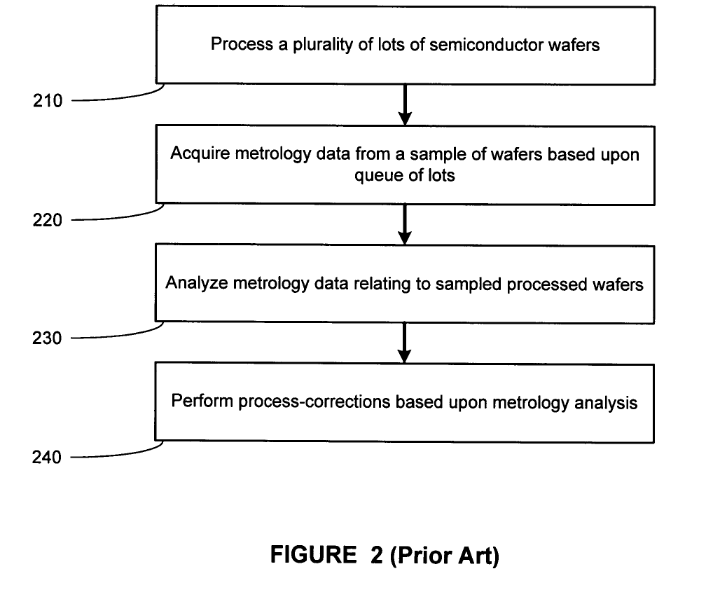

FIG. 3 provides a block diagram representation of a system in accordance with one illustrative embodiment of the present invention;

FIG. 4 illustrates a more detailed block diagram representation of a tool state data acquisition unit of FIG. 3, in accordance with one illustrative embodiment of the present invention;

FIG. 5 illustrates a more detailed block diagram representation of a metrology dispatch unit of FIG. 3, in accordance with one illustrative embodiment of the present invention;

FIG. 6 illustrates a more detailed block diagram representation of the system shown in FIG. 3, in accordance with one illustrative embodiment of the present invention;

FIG. 7 illustrates a flowchart depiction of a method in accordance with one illustrative embodiment of the present invention; and

FIG. 8 illustrates a more detailed flowchart depiction of a method of performing a dynamic metrology routing adjustment process, as indicated in FIG. 7, in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

There are many discrete processes that are involved in semiconductor manufacturing. Many times, workpieces (e.g., semiconductor wafers 105, semiconductor devices, etc.) are stepped through multiple manufacturing process tools. Embodiments of the present invention provide for assessing the tool health of particular processing tools and correlating them with wafer-lot/batch data. Upon this correlation, a determination may be made regarding the routing of lots/batch of semiconductor wafers 105 for metrology analysis.

Additionally, a fault detection analysis may be performed and analysis of tool health and fault information may be correlated. This process may be used to provide a correlation between the tool health and certain wafer lots. Based upon this correlation, adjustments to the routing of certain lots may be made. For example, if a wafer lot is queued at the tenth position in a queue for metrology analysis, based upon the correlation of fault detection data and tool health data, certain lots may be re-assigned their position in queue. Furthermore, sample rates of the semiconductor wafers 105 that are analyzed within a lot/batch of semiconductor wafers 105 may be modified to perform more rigorous metrology analyses. The particular lot being correlated with a tool health violation may be useful in performing more efficient metrology routing and for triggering alarms to process managers.

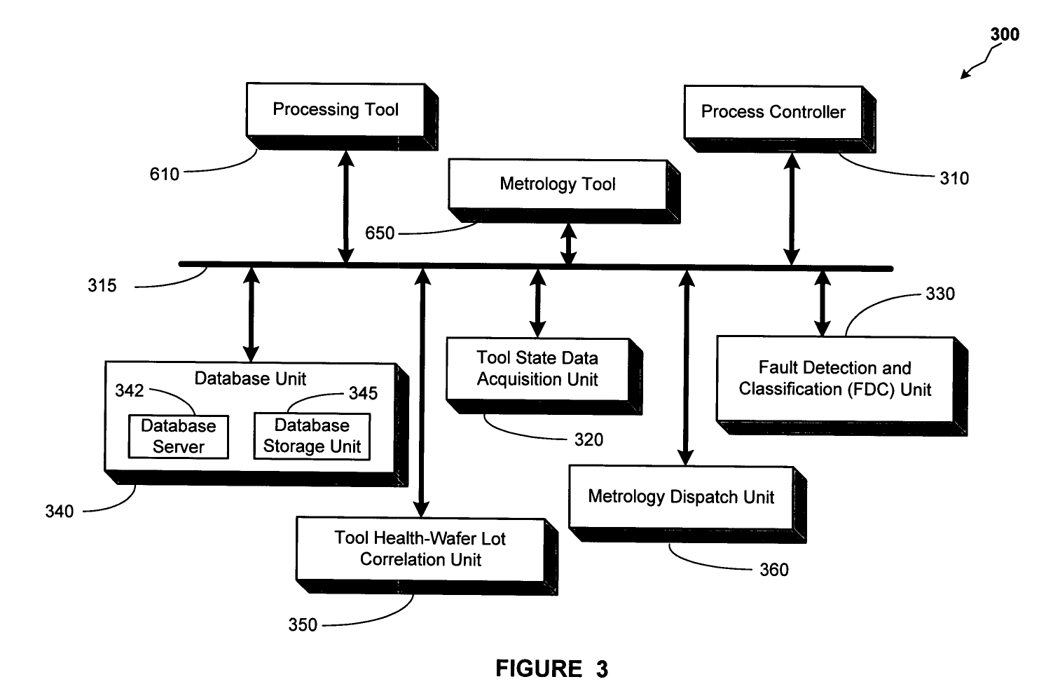

Turning now to FIG. 3, a block diagram depiction of a system 300 in accordance with embodiments of the present invention is illustrated. A process controller 310 in the system 300 is capable of controlling various operations relating to a processing tool 610. The system 300 is capable of acquiring manufacturing related data, such as metrology data related to processed semiconductor wafers 105, tool state data, and the like. The system 300 may also comprise a metrology tool 650 to acquire metrology data related to the processed semiconductor wafers 105.

The system 300 may also comprise a database unit 340. The database unit 340 is provided for storing a plurality of types of data, such as manufacturing-related data, data related to the operation of the system 300 (e.g., the status of the processing tool 610, the status of semiconductor wafers 105, etc.). The database unit 340 may store tool state data relating to a plurality of process runs performed by the processing tool 610. The database unit 340 may comprise a database server 342 for storing tool state data and/or other manufacturing data related to processing semiconductor wafers 105 into a database storage unit 345.

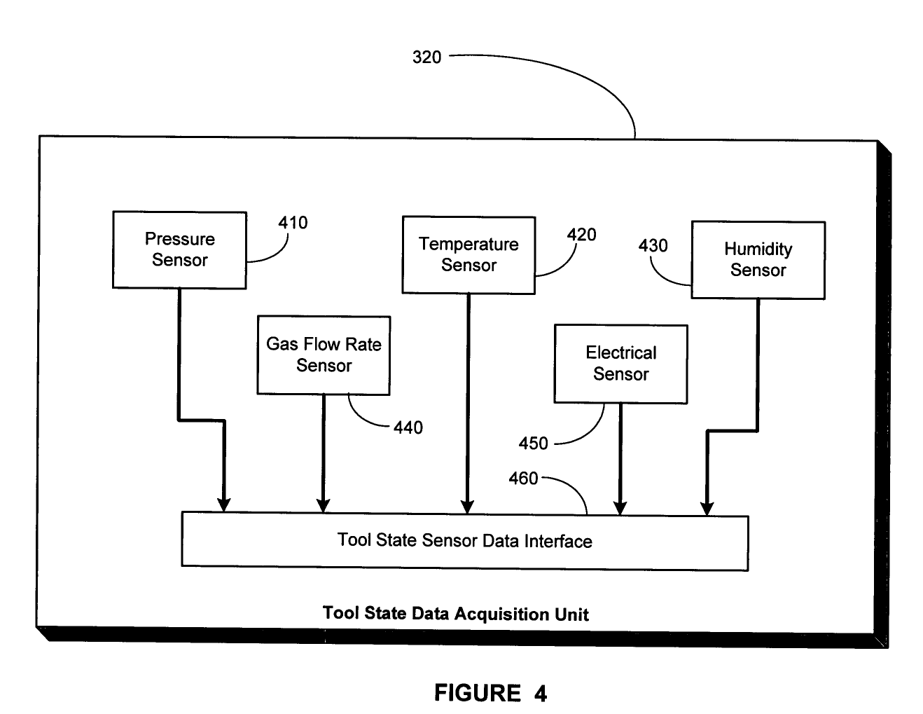

The system 300 may also comprise a tool state data acquisition unit 320 for acquiring tool state data. The tool state data may include pressure data, temperature data, humidity data, gas flow data, various electrical data, and the like, related to operations of the processing tool 610. Exemplary tool state data for an etch tool may include gas flow, chamber pressure, chamber temperature, voltage, reflected power, backside helium pressure, RF tuning parameters, etc. Tool state data may also include data external to the processing tool 610, such as ambient temperature, humidity, pressure, etc. A more detailed illustration and description of the tool state data acquisition unit 320 is provided in FIG. 4 and accompanying description below.

The system 300 also comprises a fault detection and classification unit (FDC) 330 capable of performing various fault detection analyses relating to the processing of semiconductor wafers 105. The fault detection and classification unit 330 is capable of providing data relating to faults during processing of semiconductor wafers 105. Fault detection analysis performed by the fault detection and classification unit 330 may include analysis of tool state data and/or metrology data. The FDC unit 330 may correlate particular tool state data to errors detected on the processed semiconductor wafer 105 by analyzing the metrology tool data. For example, particular errors, such as critical dimension errors discovered on the processed semiconductor wafers 105 may be correlated to particular gas flow rates or temperature data relating to tool state data. The fault detection performed by the FDC unit 330 may also include analyzing data from in situ sensors integrated into the processing tools 610.

The system 300 may also comprise a tool health-wafer lot correlation unit 350, which is capable of correlating the tool health violations detected by the system 300 with particular wafer lots/batches of semiconductor wafers 105. When a particular fault relating to a processing tool 610 is detected by the tool state data acquisition unit 320 and/or by the FDC unit 330, an assessment of the tool health may be performed. Based upon this assessment, particular batches of semiconductor wafers 105 that were processed by that particular processing tool 610 are then correlated and tracked within the system 300. Based upon this correlation, an analysis may be performed indicating that more scrutinizing metrology data may be required for further analysis from the particular lot. For example, the wafer lot that is correlated with the particular tool health violation may be moved to the front of a queue awaiting metrology analysis. This process may also be used to de-prioritize wafer lots based upon determined tool health threshold limits.

Furthermore, the sampling rate of the number of semiconductor wafers 105 that are to be analyzed within the lot may be increased or decreased based upon the correlation described above. A metrology dispatch unit 360 is then capable of reassigning a routing scheme for routing particular lots to priority metrology data analysis routing. This may include re-routing certain lots out of the queue and moving them forward to a metrology analysis station, which may comprise metrology tools 650. This allows for more efficient analysis of errors and faster corrective action may be implemented to correct certain tool-health violations or certain faults with a particular batch/lot of wafers 105.

The tool health-wafer lot correlation unit 350 is also capable of logging the type/classification of errors that are discovered and associating them with particular wafer lots. Furthermore, the tool health-wafer lot correlation unit 350 is capable of providing data to the FDC unit 330; such data may be used to perform revisions or updates to an FDC model that is embedded in the FDC unit 330. Therefore, if a false alarm is activated, i.e., the tool health-wafer lot correlation unit 350 determines that the correlation does not result in any type of appreciable error in either the tool health or the wafer lot, the FDC unit 330 may utilize a certain number of such false alarms to update the FDC model and/or generate a new model that is more tolerant. The tool health-wafer lot correlation unit 350 may also trigger particular alarms based upon the number of correlation of tool-health violations to particular lots. Upon the exceeding of a predetermined threshold of number of tool-health violations, particular alarms may be invoked to alert personnel associated with the system 300.

The process controller 310, the FDC unit 330, the tool health-wafer lot correlation unit 350, and/or the metrology dispatch unit 360 may be software, hardware, or firmware units that are standalone units or may be integrated into a computer system associated with the system 300. Furthermore, the various components represented by the blocks illustrated in FIG. 3 may communicate with one another via a system communications line 315. The system communications line 315 may be a computer bus link, a dedicated hardware communications link, a telephone system communications link, a wireless communications link, or other communication links that may be implemented by those skilled in the art having benefit of the present disclosure.

Turning now to FIG. 4, a more detailed block diagram depiction of the tool state data acquisition unit 320 illustrated in FIG. 3 is provided. The tool state data acquisition unit 320 may comprise any of a variety of different types of sensors, e.g., a pressure sensor 410, a temperature sensor 420, a humidity sensor 430, a gas flow rate sensor 440, and an electrical sensor 450, etc. In an alternative embodiment, the tool state data acquisition unit 320 may comprise in situ sensors that are integrated into the processing tool 610. The pressure sensor 410 is capable of detecting the pressure within the processing tool 610. The temperature sensor 420 is capable of sensing the temperature of various portions of the processing tool 610. The humidity sensor 430 is capable of detecting the relative humidity at various portions in the processing tool 610, or of the surrounding ambient conditions. The gas flow rate sensor 440 may comprise a plurality of flow-rate sensors that are capable of detecting the flow-rate of a plurality of process gases utilized during processing of semiconductor wafers 105. For example, the gas flow rate sensor 440 may comprise sensors that can detect the flow rate of gases such as NH₃, SiH₄, N₂, N₂O, and/or other process gases.

In one embodiment, the electrical sensor 450 is capable of detecting a plurality of electrical parameters, such as the current provided to a lamp used in a photolithography process. The tool state data acquisition unit 320 may also comprise other sensors capable of detecting a variety of manufacturing variables known to those skilled in the art having benefit of the present disclosure. The tool state data acquisition unit 320 may also comprise a tool state sensor data interface 460. The tool state sensor data interface 460 may receive sensor data from the various sensors that are contained within, or associated with, the processing tool 610 and/or the tool state data acquisition unit 320 and transmit the data to the process controller 310.

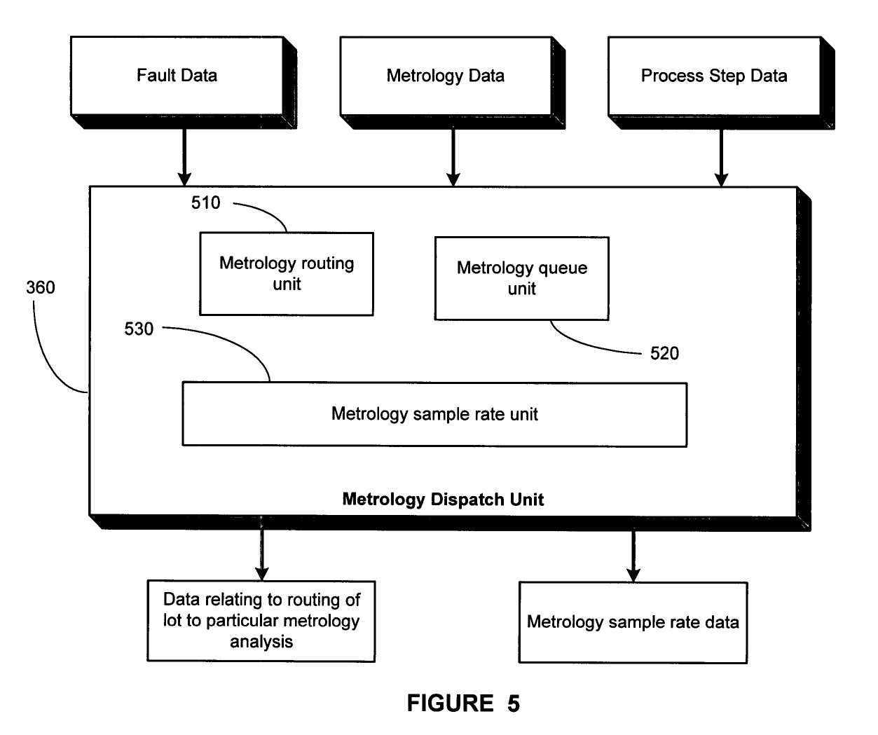

Turning now to FIG. 5, a more detailed block diagram depiction of one embodiment of the metrology dispatch unit 360 is illustrated. The metrology dispatch unit 360 may receive fault data from the FDC unit 330, metrology data from one or more metrology tools 650 and/or process step data, which relates to the type of processes that are to be performed on lots that are waiting in queue. The data received by the metrology dispatch unit 360 may be used to determine dispatching adjustment and/or other corrective steps to be taken, such as modifying the sampling rate of semiconductor wafers 105 that are analyzed within a lot, and the like. The metrology dispatch unit 360 may comprise a metrology routing unit 510, a metrology queue unit 520, and a metrology sample rate unit 530. The metrology queue unit 520 is capable of making an assessment of the position in queue of a particular lot/batch. Based upon this assessment along with the correlation made by the tool health-wafer lot correlation unit 350, the metrology queue unit 520 may determine that the queue position of a particular lot should to be changed. For example, a lot that is in queue in the tenth position, may be put at the front of the queue for expedited analysis before further processes are performed by the processing tool 610 that is suspect, or before further processes are performed on wafers 105 in the lot.

Based upon the metrology queue unit 520 analysis, the metrology routing unit 510 may modify the route of a particular lot to certain metrology stations for expedited metrology analysis. Additionally, the metrology sample rate unit 530 may modify the number of wafers 105 within the lot that are analyzed by a metrology tool 650. For example, for a particular process, if the rate at which semiconductor wafers 105 are examined are one per five wafers 105, the metrology sample rate unit 530, based upon correlation of tool health and wafer lot analysis, may determine that one out of every two wafers 105 within the lot should be analyzed for closer metrology scrutiny. Alternatively, in the same example, one out of ten wafers 105 may be analyzed in response to tool health/wafer-lot data analysis. Based upon the analysis performed by the metrology dispatch unit 360, data relating to the routing of lots to particular metrology analysis is provided and data relating to metrology sample rates is also provided. This data may then be used by the process controller 310 to route certain lots to particular metrology stations and implement newly adjusted sample rates. Therefore, the metrology dispatch unit 360 modifies the routing of particular lots based upon the analysis performed by the tool health-wafer lot correlation unit 350.

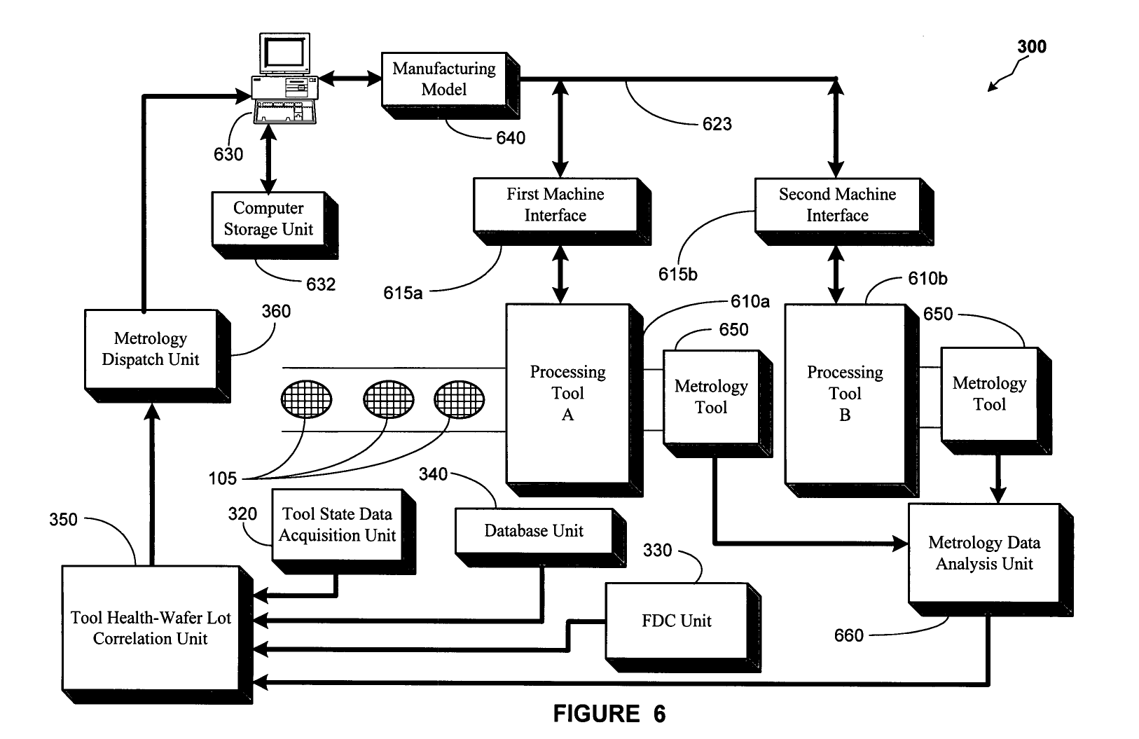

Turning now to FIG. 6, a more detailed block diagram of the system 300 in accordance with one embodiment of the present invention is illustrated. Semiconductor wafers 105 are processed on processing tools 610a, 610b using a plurality of control input signals, or manufacturing parameters, provided via a line or network 623. The control input signals, or manufacturing parameters, on the line 623 are sent to the processing tools 610a, 610b from a computer system 630 via machine interfaces 615a, 615b. The first and second machine interfaces 615a, 615b are generally located outside the processing tools 610a, 610b. In an alternative embodiment, the first and second machine interfaces 615a, 615b are located within the processing tools 610a, 610b. The semiconductor wafers 105 are provided to and carried from a plurality of processing tools 610. In one embodiment, semiconductor wafers 105 may be provided to a processing tool 610 manually. In an alternative embodiment, semiconductor wafers 105 may be provided to a processing tool 610 in an automatic fashion (e.g., robotic movement of semiconductor wafers 105). In one embodiment, a plurality of semiconductor wafers 105 is transported in lots (e.g., stacked in cassettes) to the processing tools 610.

In one embodiment, the computer system 630 sends control input signals, or manufacturing parameters, on the line 623 to the first and second machine interfaces 615a, 615b. The computer system 630 is capable of controlling processing operations. In one embodiment, the computer system 630 is a process controller. The computer system 630 is coupled to a computer storage unit 632 that may contain a plurality of software programs and data sets. The computer system 630 may contain one or more processors (not shown) that are capable of performing the operations described herein. The computer system 630 employs a manufacturing model 640 to generate control input signals on the line 623. In one embodiment, the manufacturing model 640 contains a manufacturing recipe that determines a plurality of control input parameters that are sent on the line 623 to the processing tools 610a, 610b.

In one embodiment, the manufacturing model 640 defines a process script and input control that implement a particular manufacturing process. The control input signals (or control input parameters) on the line 623 that are intended for processing tool A 610a are received and processed by the first machine interface 615a. The control input signals on the line 623 that are intended for processing tool B 610b are received and processed by the second machine interface 615b. Examples of the processing tools 610a, 610b used in semiconductor manufacturing processes are steppers, etch process tools, deposition tools, and the like.

One or more of the semiconductor wafers 105 that are processed by the processing tools 610a, 610b can also be sent to a metrology tool 650 for acquisition of metrology data. The metrology tool 650 may be a scatterometry data acquisition tool, an overlay-error measurement tool, a critical dimension measurement tool, and the like. In one embodiment, a metrology tool 650 examines one or more processed semiconductor wafers 105. The metrology data analysis unit 660 may collect, organize, and analyze data from the metrology tool 650. The metrology data is directed to a variety of physical or electrical characteristics of the devices formed across the semiconductor wafers 105. For example, metrology data may be obtained as to line width measurements, depth of trenches, sidewall angles, thickness, resistance, and the like. Metrology data may be used to determine faults that may be present across the processed semiconductor wafers 105, which may be used to quantify the performance of the processing tools 610.

As described above, the FDC unit 330 provides fault detection data that may provide fault data relating to particular processing tools 610 and/or faults associated with certain lots of semiconductor wafers 105. The database unit 340 may also store processed data and/or tool health data, which may be sent to the tool health-wafer lot correlation unit 350. Additionally, the tool state data acquisition unit 320 provides the tool health-wafer lot correlation unit 350 with data relating to the state of the processing tool 610, such as pressure, temperature, humidity, etc. Based upon the analysis performed by the tool health-wafer lot correlation unit 350, the metrology dispatch unit 360 provides routing data and sample rate data to the computer system 630. The computer system 630 is then capable of implementing the modified routing and sample rate implementations for particular lots of semiconductor wafers 105.

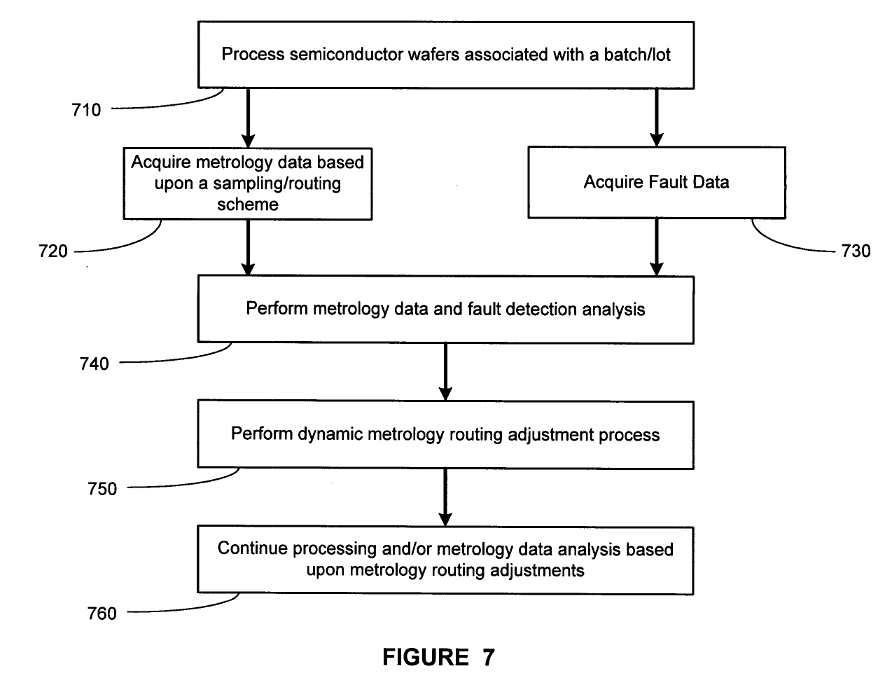

Turning now to FIG. 7, a flow chart depiction of the methods in accordance with embodiments of the present invention is illustrated. The system 300 processes semiconductor wafers 105 associated with a particular batch/lots (block 710). Upon processing of semiconductor wafers 105, metrology data is generally acquired based upon a sampling and a predetermined routing scheme (block 720). In other words, processed lots of semiconductor wafers 105 are placed in a routing scheme that may contain a queue and are then routed to particular metrology stations for metrology data acquisition. Predetermined sampling rates may be used to sample particular numbers of semiconductor wafers 105 within a lot for metrology analysis.

The system 300 may also acquire fault data using the fault detection analysis described above (block 730). The fault data may include tool state data, which may indicate certain faults or unusual violations associated with the tool health of a particular processing tool 610. Fault data may comprise faults associated with particular operation of processing tools 610 and/or faults associated with a processed semiconductor wafers 105. The metrology data and the fault data are then used to perform an analysis to determine whether significant errors or tool health violations are present (block 740).

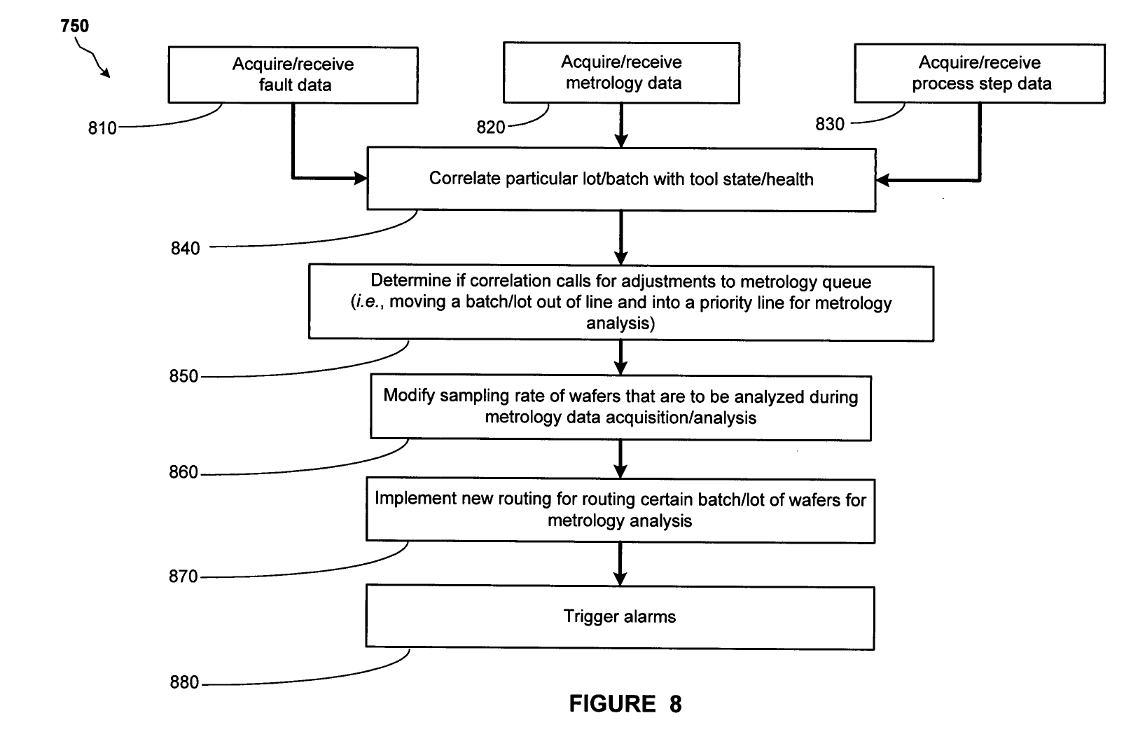

Upon analysis of the metrology data and fault detection analysis, the system 300 may perform a dynamic routing adjustment process, which may include correlating certain tool-health violations with particular lots (block 750). A more detailed description of the dynamic metrology routing adjustment unit is provided in FIG. 8 and accompanying description below. Upon performing the dynamic metrology routing adjustment process, data relating to a modified metrology routing scheme and/or data relating to an adjusted sample rate data are provided to the system 300. The system 300 may continue processing the semiconductor wafers 105 and/or perform metrology data analysis based upon newly adjusted metrology routing adjustments (block 760). In other words, the dynamic metrology routing adjustment process may be used to determine that a routing adjustment or a sample rate adjustment is not required. Therefore, normal processing flow will continue.

Conversely, if based upon the dynamic metrology routing adjustment process it is determined that metrology routing adjustments and/or adjustments to the sample rate of semiconductor wafers 105 analyzed within the lot should be performed, the new routing scheme and sample rate are implemented for more scrutinized metrology data analysis. Based upon this analysis, a determination may be made that a particular processing tool 610 is operating ineffectively. Alternatively, it may be determined that a particular batch/lot of semiconductor wafers 105 may be defective and must be reworked or processed in another manner. Additionally, the dynamic metrology data routing adjustment process may be used to determine that neither the processing tool 610 nor the batch/lot is at significant risk of performing poorly, therefore, tolerance levels that trigger faults or errors may be eased so smoother processing flow may be achieved.

Turning now to FIG. 8, a more detailed flowchart depiction of the dynamic metrology routing adjustment process indicated in block 750 of FIG. 7 is illustrated. The system 300 may acquire or receive fault data, which may include faults relating to processing tools 610, wafers 105, tool health etc. (block 810). The system 300 may also acquire and receive metrology data (block 820) and process step data, which may be indicative of the type of processes to be performed on particular lots of semiconductor wafers 105 (block 830). The system 300 may then correlate a particular batch/lot of semiconductor wafers 105 to a particular tool state/health (block 840). Certain tool-health violations may be correlated to particular lots and isolated to certain relationships between the particular lot and the tool health violations.

The system 300 then determines if the correlation calls for adjustments to the metrology queue, which may include moving the batch/lot out of line into a priority position for more scrutinized metrology analysis (block 850). The dispatch may be based upon the severity of the failures that are discovered or the viability of correction based upon additional metrology data analysis. The system 300 may also modify the sampling rate at which particular semiconductor wafers 105 within a lot are analyzed by a metrology tool 650 (block 860). The system 300 may then implement the new routing scheme for routing a certain batch/lot of semiconductor wafers 105 for additional metrology analysis (block 870). Additionally, the system may trigger additional alarms based upon the severity and the number of correlation faults that are detected (block 880). The completion of the steps describes in FIG. 8 substantially completes the process of performing the dynamic metrology routing adjustment process indicated in block 750 of FIG. 7.

Utilizing the embodiments of the present invention, a more efficient metrology routing scheme may be implemented based upon correlation of the tool health to certain wafer lots. Therefore, before additional or unnecessary work is performed on particular lots, a modified metrology routing may be implemented to acquire metrology analysis more efficiently. This expedited metrology analysis may result in a particular processing tool 610 being modified, particular lots being processed in a different manner than originally scheduled, and/or modification of certain tolerance levels that trigger certain types of faults within the semiconductor wafers 105 or the processing tools 610. Utilizing embodiments of the present invention, more efficient process flows may be generated resulting in more efficient processing of semiconductor wafers 105. Yields of processed semiconductor wafers 105 may increase when certain processing tools 610 are corrected based upon expedited acquisition of metrology data.

The principles taught by the present invention can be implemented in an Advanced Process Control (APC) Framework, such as a Catalyst system offered by KLA Tencor, Inc. The Catalyst system uses Semiconductor Equipment and Materials International (SEMI) Computer Integrated Manufacturing (CIM) Framework compliant system technologies, and is based on the Advanced Process Control (APC) Framework. CIM (SEMI E81-0699-Provisional Specification for CIM Framework Domain Architecture) and APC (SEMI E93-0999-Provisional Specification for CIM Framework Advanced Process Control Component) specifications are publicly available from SEMI. The APC framework is a preferred platform from which to implement the control strategy taught by the present invention. In some embodiments, the APC framework can be a factory-wide software system; therefore, the control strategies taught by the present invention can be applied to virtually any of the semiconductor manufacturing tools on the factory floor. The APC framework also allows for remote access and monitoring of the process performance. Furthermore, by utilizing the APC framework, data storage can be more convenient, more flexible, and less expensive than local drives. The APC framework allows for more sophisticated types of control because it provides a significant amount of flexibility in writing the necessary software code.

Deployment of the control strategy taught by the present invention onto the APC framework could require a number of software components. In addition to components within the APC framework, a computer script is written for each of the semiconductor manufacturing tools involved in the control system. When a semiconductor manufacturing tool in the control system is started in the semiconductor manufacturing fab, it generally calls upon a script to initiate the action that is required by the process controller, such as the overlay controller. The control methods are generally defined and performed in these scripts. The development of these scripts can comprise a significant portion of the development of a control system. The principles taught by the present invention can be implemented into other types of manufacturing frameworks.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
performing a process step upon a batch of workpieces using a processing tool;
performing a tool state analysis upon said processing tool; and
performing a dynamic metrology routing adjustment process based upon said tool state analysis, said dynamic metrology routing adjustment process further comprises correlating said tool state analysis to said batch of workpieces and adjusting a metrology routing based upon said correlation.

2. The method of claim 1, wherein performing said process step upon said batch of workpieces further comprises performing said process step upon a batch of semiconductor wafers.

3. The method of claim 1, wherein performing said tool state analysis upon said processing tool further comprises acquiring tool state data.

4. The method of claim 2, wherein acquiring said tool state data further comprises acquiring at least one of a pressure data, a temperature data, a humidity data, and a gas flow rate data relating to said process step performed upon said workpiece.

5. The method of claim 1, wherein performing said tool state analysis upon said processing tool further comprises performing a tool health analysis relating to said processing tool.

6. The method of claim 1, further comprising performing a fault detection analysis relating to said processing of said batch.

7. The method of claim 6, wherein said fault detection analysis further comprises determining at least one fault relating to an operation performed by said processing tool.

8. The method of claim 6, wherein said fault detection analysis further comprises determining at least one fault relating to said batch.

9. The method of claim 1, wherein performing said dynamic metrology routing adjustment process further comprises modifying the position of said batch in a metrology queue.

10. The method of claim 1, wherein performing said dynamic metrology routing adjustment process further comprises modifying a sampling rate relating to a number of workpieces being analyzed by a metrology tool.

11. The method of claim 1, wherein performing said dynamic metrology routing adjustment process further comprises triggering an alarm to indicate a correlation of tool health violations to a batch.

12. The method of claim 11, wherein performing said dynamic metrology routing adjustment process further comprises modifying a fault tolerance level associated with said tool health violation.

13. A method, comprising:
performing a process step upon a plurality of batches of workpieces using a processing tool;
performing a tool health analysis upon said processing tool;
performing a fault detection analysis relating to said processing of said batches of workpieces;
correlating said tool health assessment to at least one of said batches of workpieces based upon said tool health analysis and said fault detection analysis; and
adjusting a metrology routing of at least one of said batches of workpieces based upon said correlation.

14. The method of claim 13, wherein performing said process step upon said batches of workpieces further comprises performing said process step upon batches of semiconductor wafers.

15. The method of claim 13, wherein performing said dynamic metrology routing adjustment process further comprises modifying a sampling rate relating to a number of workpieces being analyzed by a metrology tool.

16. An apparatus, comprising:
means for performing a process step upon a batch of workpieces using a processing tool;
means for performing a tool state analysis upon said processing tool; and
means for performing a dynamic metrology routing adjustment process based upon said tool state analysis, said dynamic metrology routing adjustment process further comprises correlating said tool state analysis to said batch of workpieces and adjusting a metrology routing based upon said correlation.

17. A system, comprising:
a processing tool to process a batch of workpieces; and
a process controller operatively coupled to perform a tool state analysis upon said processing tool and to perform a dynamic metrology routing adjustment process based upon said tool state analysis, said dynamic metrology routing adjustment process further comprises correlating said tool state analysis to said batch of workpieces and adjusting a metrology routing based upon said correlation.

18. The system of claim 17, wherein said workpieces are semiconductor wafers.

19. The system of claim 17, further comprising:
a tool state data acquisition unit operatively coupled to said process controller and to said processing tool, said tool state data acquisition unit to acquire tool state data relating to an operation performed by said processing tool;
a metrology tool operatively coupled to said process controller and to said processing tool, said metrology tool to acquire metrology data relating to said processed workpiece;
a fault detection and classification (FDC) unit operatively coupled to said process controller, said fault detection and classification unit to perform said fault detection process;
a tool health-wafer lot correlation unit operatively coupled to said FDC unit and to said tool state data acquisition unit, said tool health-wafer lot correlation unit to perform a correlation of the tool health relating to said batch of workpieces; and
a metrology dispatch unit operatively coupled to said tool health-wafer lot correlation unit, said metrology dispatch unit to adjust a metrology dispatch of a batch of workpieces for metrology analysis.

20. The system of claim 19, further comprising a database unit to store said at least one of metrology data, said tool state data, and said electrical test data.

21. The system of claim 20, wherein said tool state data acquisition unit comprises at least one of a pressure sensor, gas flow sensor, temperature sensor, humidity sensor, and an electrical sensor.

22. An apparatus, comprising:
a process controller operatively coupled to perform a tool state analysis upon a processing tool that is capable of processing a batch of workpieces and to perform a dynamic metrology routing adjustment process based upon said tool state analysis, said dynamic metrology routing adjustment process further comprises correlating said tool state analysis to said batch of workpieces and adjusting a metrology routing based upon said correlation.

23. The apparatus of claim 22, wherein said workpiece is a semiconductor wafer.

24. The apparatus of claim 22, further comprising:
a tool state data acquisition unit operatively coupled to said process controller and to said processing tool, said tool state data acquisition unit to acquire tool state data relating to an operation performed by said processing tool;
a metrology tool operatively coupled to said process controller and to said processing tool, said metrology tool to acquire metrology data relating to said processed workpiece;
a fault detection and classification (FDC) unit operatively coupled to said process controller, said fault detection and classification unit to perform said fault detection process;
a tool health-wafer lot correlation unit operatively coupled to said FDC unit and to said tool state data acquisition unit, said tool health-wafer lot correlation unit to perform a correlation of the tool health relating to said batch of workpieces; and
a metrology dispatch unit operatively coupled to said tool health-wafer lot correlation unit, said metrology dispatch unit to adjust a metrology dispatch of a batch of workpieces for metrology analysis.

25. The apparatus of claim 24, wherein said tool state data acquisition unit comprises at least one of a pressure sensor, gas flow sensor, temperature sensor, humidity sensor, and an electrical sensor.

26. A computer readable program storage device encoded with instructions that, when executed by a computer, performs a method, comprising:
performing a process step upon a batch of workpieces using a processing tool;
performing a tool state analysis upon said processing tool; and
performing a dynamic metrology routing adjustment process based upon said tool state analysis, said dynamic metrology routing adjustment process further comprises correlating said tool state analysis to said batch of workpieces and adjusting a metrology routing based upon said correlation.

27. The computer readable program storage device encoded with instructions that, when executed by a computer, performs the method of claim 26, wherein performing said process step upon said batch of workpieces further comprises performing said process step upon a batch of semiconductor wafers.

28. The computer readable program storage device encoded with instructions that, when executed by a computer, performs the method of claim 26, wherein performing said tool state analysis upon said processing tool further comprises acquiring tool state data.

29. The computer readable program storage device encoded with instructions that, when executed by a computer, performs the method of claim 28, wherein acquiring said tool state data further comprises acquiring at least one of a pressure data, a temperature data, a humidity data, and a gas flow rate data relating to said process step performed upon said workpiece,

30. The computer readable program storage device encoded with instructions that, when executed by a computer, performs the method of claim 26, wherein performing said tool state analysis upon said processing tool further comprises performing a tool health analysis relating to said processing tool.

31. The computer readable program storage device encoded with instructions that, when executed by a computer, performs the method of claim 26, further comprising performing a fault detection analysis relating to said processing of said batch.

32. The computer readable program storage device encoded with instructions that, when executed by a computer, performs the method of claim 31, wherein said fault detection analysis further comprises determining at least one fault relating to an operation performed by said processing tool.

33. The computer readable program storage device encoded with instructions that, when executed by a computer, performs the method of claim 31, wherein said fault detection analysis further comprises determining at least one fault relating to said batch.

34. The computer readable program storage device encoded with instructions that, when executed by a computer, performs the method of claim 26, wherein performing said dynamic metrology routing adjustment process further comprises modifying the position of said batch in a metrology queue.

35. The computer readable program storage device encoded with instructions that, when executed by a computer, performs the method of claim 26, wherein performing said dynamic metrology routing adjustment process further comprises modifying a sampling rate relating to a number of workpieces being analyzed by a metrology tool.

36. The computer readable program storage device encoded with instructions that, when executed by a computer, performs the method of claim 26, wherein performing said dynamic metrology routing adjustment process further comprises triggering an alarm to indicate a correlation of tool health violation to a batch.

37. The computer readable program storage device encoded with instructions that, when executed by a computer, performs the method of claim 36, wherein performing said dynamic metrology routing adjustment process further comprises modifying a fault tolerance level associated with said tool health violation.

38. A method, comprising:
performing a process step upon a batch of workpieces using a processing tool;
performing a tool state analysis upon said processing tool; and
performing a dynamic metrology routing adjustment process based upon said tool state analysis, said dynamic metrology routing adjustment process further comprises correlating said tool state analysis to said batch of workpieces and adjusting a metrology routing based upon said correlation, adjusting said metrology routing comprising modifying the position of said batch in a metrology queue.

39. The method of claim 38, wherein performing said process step upon said batch of workpieces further comprises performing said process step upon a batch of semiconductor wafers.

40. The method of claim 38, wherein performing said tool state analysis upon said processing tool further comprises acquiring tool state data.

41. The method of claim 40, wherein acquiring said tool state data further comprises acquiring at least one of a pressure data, a temperature data, a humidity data, and a gas flow rate data relating to said process step performed upon said workpiece.

42. A system, comprising:
a processing tool to process a batch of workpieces; and
a process controller operatively coupled to perform a tool state analysis upon said processing tool and to perform a dynamic metrology touting adjustment process based upon said tool state analysis, said dynamic metrology routing adjustment process further comprises correlating said tool state analysis to said batch of workpieces and adjusting a metrology routing based upon said correlation, said process controller being adapted to modify the position of said batch in a metrology queue.

43. The system of claim 42, wherein said workpieces are semiconductor wafers.
